(19) United States
(12) Patent Application Publication
(10) Pub. No.: US 2011/0094831 A1
(43) Pub. Date: Apr. 28, 2011

(54) DEVICE FOR STRETCHING COMPENSATION IN LIFT CABLES

(76) Inventor: Giorgio Jezek, Cognola di Trento (IT)

(21) Appl. No.: 11/911,715

(22) PCT Filed: Dec. 12, 2005
(86) PCT No.: PCT/IB05/03906

§ 371 Date: Jan. 10, 2011

(30) Foreign Application Priority Data
May 13, 2005 (IT) BZ2005A000021
May 23, 2005 (IT) BZ2005A000022

(51) Int. Cl. B66B 7/10

(52) U.S. Cl. 187/264

(57) ABSTRACT

The invention relates to a device for stretching compensation in lift cables, arranged within a lift unit, with a lift shaft, a cabin (1) (FIGS. 1 and 2), a counter-weight (7) (FIGS. 1 and 2), at least one lift cable (3) (image 1), said cabin and said counter-weight on the pulley (4) (image 1 and 2) and a cable (9) (FIGS. 1 and 2) connected to the underside of the cabin and the counter-weight (FIG. 2) running around the freely-rotating pulley (10) (FIGS. 1 and 2) in the lift shaft. According to the invention, the device comprises a drive, mechanically connected to the end of at least one cable rod (27) (FIG. 4) on the underside of the cabin (11) (FIG. 2) and passing through pressure springs applied to the cabin cable section and a sensor (34) on the spring (12) (FIGS. 1 and 2), which serves to trigger the drive (16) (FIGS. 1, 2, 3 and 4). Two solutions to achieve automatic load compensation on a lift into which a load is charged are given.

The present invention relates to a device for stretch compensation in lift cables according to the preamble of claim 1.

The object of the invention is to provide a lift unit which upon change of the load in the cabin is in a balanced state at all times. This object is attained by realizing two principle embodiments which ere eluoldated in what follows:

1. Embodiment. Maintaining the cable length both above as well as underneath the cabin [The cables are stretched when the lift is used (time, number of rides) and the like].
2. Cable system above and underneath the cabin including a counter-weight; appropriately tensioned, loads and springs being dimensioned in accordance with the equations and drawings stated herein.

Three solutions of the second embodiment are presented.

The patent application took into account one cable. However, the lift comprises a plurality of cables with a total load of—(F₁-F₂-F₃-F₄), evenly distributed among the various cables (F to one cable—in the case of 5 cables is represented by

$$F = \frac{{F}_{1}}{5} o \frac{{F}_{2}}{5} o \frac{{F}_{3}}{5} o \frac{{F}_{4}}{5}$$

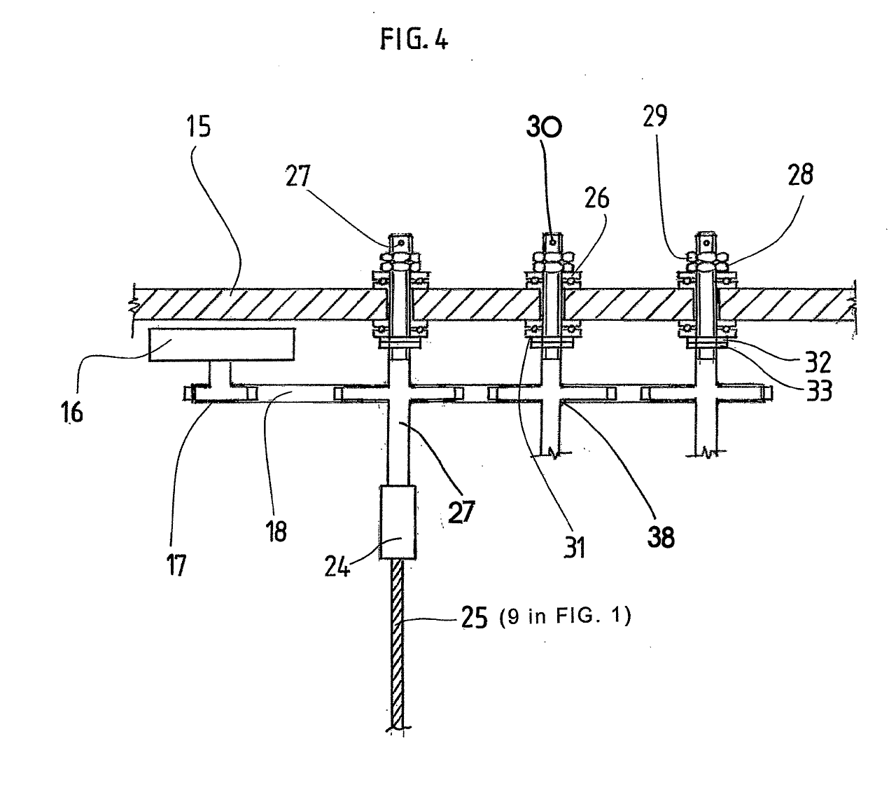

F₁ relates to the force on the spring 12—F₂ relates to the force on the spring 13—F₃ relates to the force on the spring 14—F₄ relates to the force on the plate 15 (FIG. 4).

The characteristics and details of the device according to the invention are apparent from the following description of a preferred embodiment, shown in the accompanying drawing. There is shown in

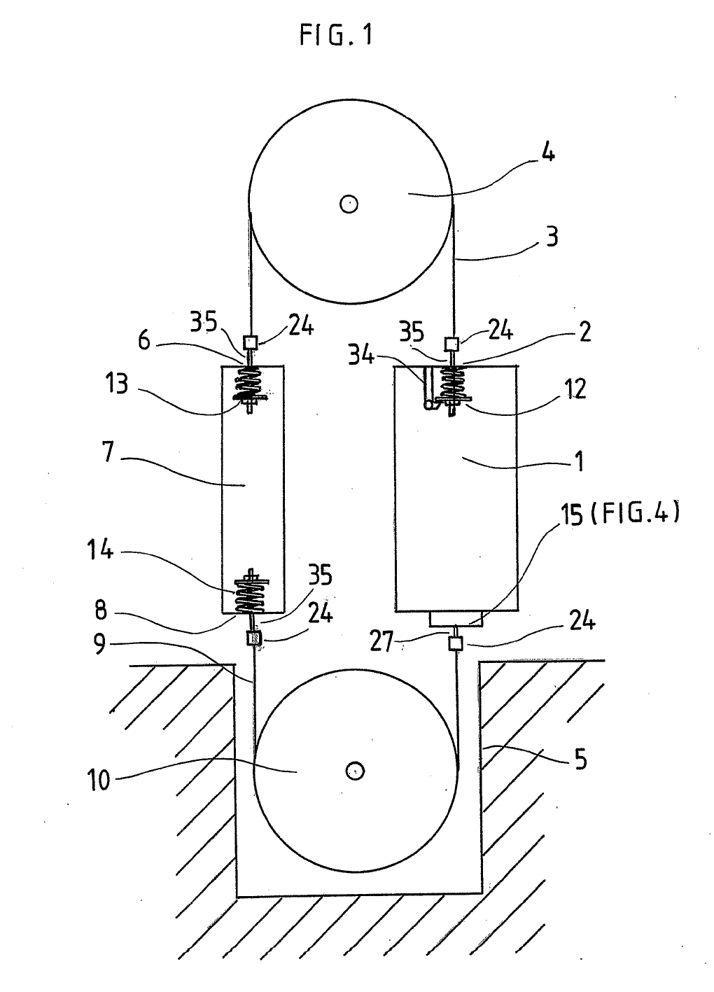

FIG. 1, schematically, a lift unit as a first solution of the second embodiment;

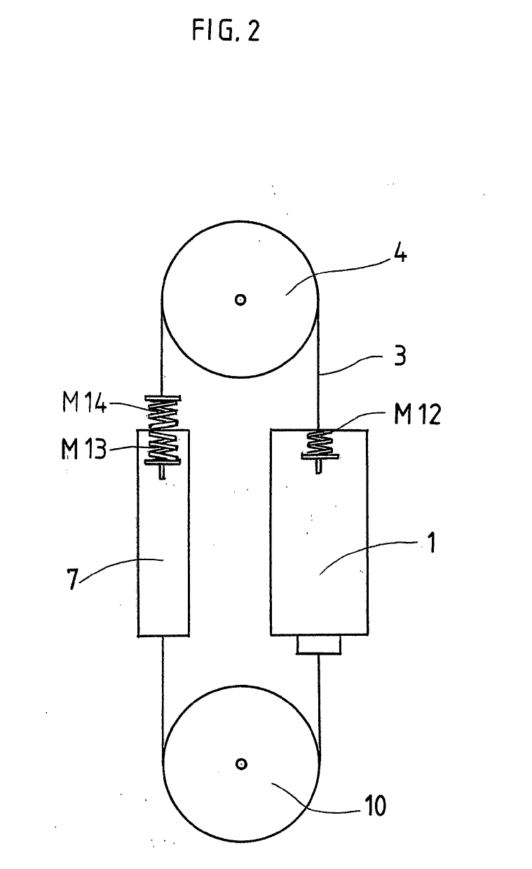

FIG. 2, schematically, a lift unit as a second solution of the second embodiment,

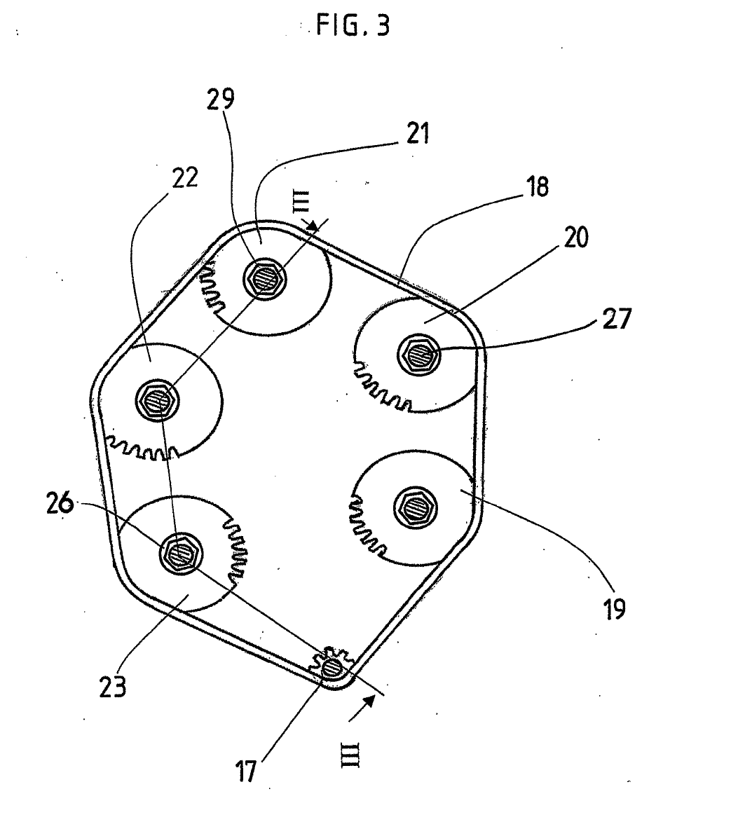

FIG. 3, a device for stretch compensation of cables,

FIG. 4, a cross-section along planes III-III according to FIG. 3

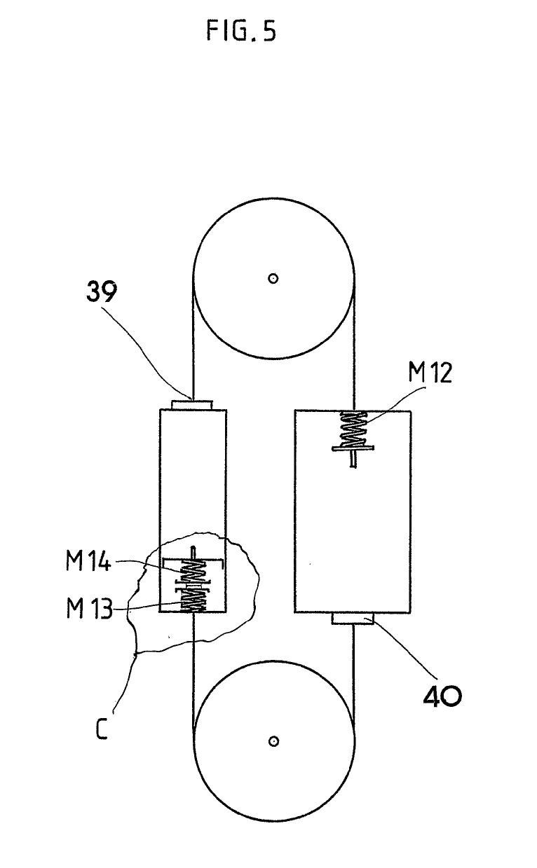

FIG. 5, a lift unit representing a third solution of the second embodiment and

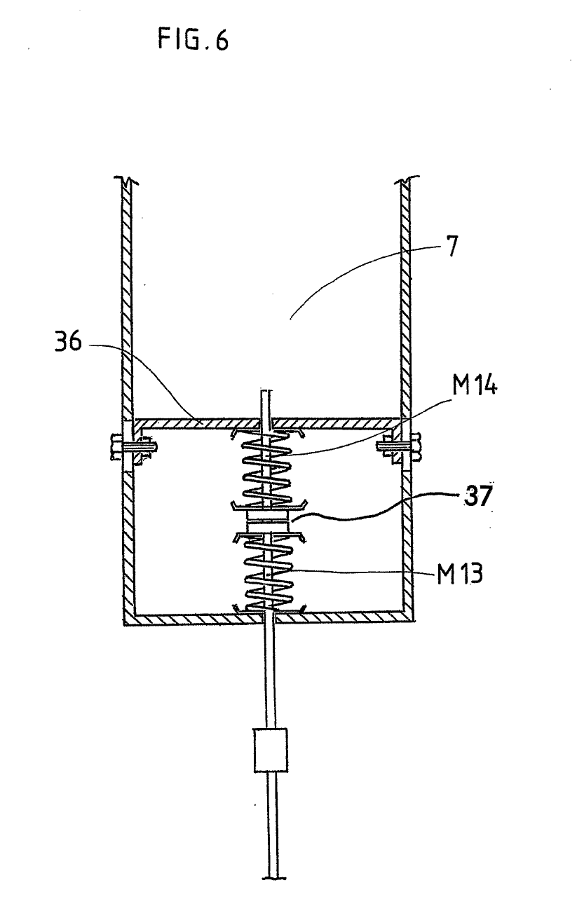

FIG. 6, the detail C in FIG. 5.

FIG. 1 shows a lift unit in its entirely, comprising, in a manner known per se, a cabin 1, suspended in position 2 from at least one cable 3, wound around a drive pulley 4 in order to be connected to a counter-weight 7 in position 6, the other end of which is connected to at least one cable 9 in position 8, deflected by a pulley 10 in order to be connected to the floor of the cabin 1 in position 11.

According to the invention, a spring 12 in position 2, a spring 13 in position 6 and a spring 14 in position 8 are inserted while in position 11 a device for adjusting the cable length is provided, which will be elucidated here in more detail.

If, according to the invention, F₁ refers to the force on the cables 3 on the cabin, F₂ refers to the force on the cables on the counter-weight, F₃ refers to the force on the cable section between the lower pulley and the counter-weight and F₄ refers to the force on the cable section between the pulley and the cabin floor, the following relationship apply in accordance with the invention:

The first solution (FIG. 1) of the 2^{nd} embodiment does not provide the load compensation for the load which bears on the cabin, but is given as an example in order to provide the first embodiment.
Taken into account is the total weight of the empty cabin=Q (nominal carrying capacity of the cabin) and corresponding to the weight of the counter-weight
One could also write

### SOLUTION 2—FIG. 2 ACCORDING TO THE SECOND EMBODIMENT

The springs M₁₂ and M₁₃ (which are identical and exhibit uniform rigidity, will be arranged as shown in the drawing) (FIG. 2) and which have a load=zero, are loaded until a load of 3 Q is attained (see degree of deformation). The spring M₁₄ likewise exhibits uniform rigidity which equals half that of the springs M₁₂ and M₁₃,

K_{M14}=½K_{M12}=½K_{M13}

For positioning and for the load on the springs M₁₂ and M₁₃, the cables are tensioned by exerting force on the nuts of their tension rods until the degree of deformation of the springs themselves corresponds to the parameter corresponding to the load (3 Q with δ=0)

(3 Q represents the load on the springs M₁₂ and M₁₃)

For adjusting the spring M₁₄ one proceeds in such manner that with (δ=0) (empty non-loaded cabin) the degree of deformation of the spring M₁₄=0 (zero) (must, however, rest on the nuts and counter nuts).

### SOLUTION 3—FIG. 5 AND FIG. 6 OF THE SECOND EMBODIMENT

The spring M₁₂ must always exhibit the same rigidity ad the spring M₁₃ and the spring M₁₄ must exhibit a rigidity which equals half that of the springs M₁₂ and M₁₃. Thus K_{M14}=½K_{M12}=½K_{M13}.

Everything relating to the positioning is set out in FIG. 5 and FIG. 6. The adjustment is performed as follows:

The load Q is loaded into the cabin and by acting upon the nuts of the cable rods, the load 4 Q (see degree of deformation) on the spring M₁₂ and the load 3 Q (see degree of deformation) on the spring M₁₃ are applied. This can be attained in that adjustable forces are exerted on the spring M₁₄ via the nut and counter nut 37 and the stop device 36 (FIG. 6).

With a cabin load which equals the nominal carrying capacity of the installation it is achieved that the degree of deformation of the springs M₁₂ and M₁₃ will differ by the value Q/K_{M12} (The degree of deformation of M₁₂ increases in comparison with M₁₃).

p=empty weight of the cabin and the weight of the counter-weight (are identical)—Newton
δ=variable calculated carrying capacity (from 0 to 1.5 Q)—Newton
Δ=Force difference and difference in degree of deformation—Newton and mm

### F=Forces—Newton

f=Degree of deformation—mm
K=Rigidity of spring—Newton/mm
Q=Nominal carrying capacity of the lift (normally=p)—Newton

### 1^{st} EMBODIMENT

The device underneath the cabin comprises a base plate 15, which is rigidly fixed to the floor of the cabin 1. On the side opposite to the floor of the cabin 1 the plate carriers a transmission 16 fitted to the plate 15. The output shaft of the transmission 16 is arranged parallel to the cables 9, rigidly carrying a pinion 17 onto which a link chain 18 is coiled, wound up on chain wheels 19, 20, 21, 22 and 23, which are wedged onto, for example welded to, the corresponding tension rods of the cable 9 (FIG. 1) or 25 (FIG. 4) in position 38.

Each cable 9 stretches within rods 27 passing through apertures in the support plate 15, each traversing a ball bearing and a thrust bearing and being screw-connected by a nut and a counter-nut 28 and 29, the free end protruding from the nut and counter-nut and being appropriately fitted with a splint 30.

The drive means is advantageously fitted to the plate 15 in an adjustable manner, for example by way of a elongate aperture, so that the tension of the link chain 18 may be adjusted. On the spring 12 a sensor is advantageously provided for measuring the change in length of the spring 12, the said sensor emitting a signal to the drive means 16 (FIGS. 3 and 4) for the latter to commence its operation, so that the pinion 17 rotates according to the torque of the cables 9 in order to compensate for the change in length of the spring.

Each rod 27 may be fitted appropriately rigidly to the underside of the plate 15 by means of a pressure bearing 31, in order to preserve the alignment of the chain.

All comments stated above are based on some of the considerations set out here:
1. The calculation of the number or cables (n) is done in accordance with the prevailing legal requirements, taking into account that the load F₁ used at position 2 is distributed uniformly to a plurality of cables (The load on one cable corresponds therefore to the load on each of the other cables). Accordingly, each cable has a load of F_{1/n}.
2. The value Δ F₁ (degree of deformation of the springs 1) may not exceed 15 mm. Calculated for a load in the cabin which equals Q (Q=nominal carrying capacity of the cabin).
3. The value Δ F₁ or δ max (maximum calculated load in the cabin) may never be below 1.5 Q.—In what is stated above, there applies δ max=1.5 Q.
4. The cables connecting the lower section of the cabin (with the deflector in the shaft) to the lower portion of the counter-weight and its springs, correspond in number, size and technical properties to the carrier cables (upper portion of the cabin-upper portion of the counter-weight). This is not necessary; —they must weight the same as the upper cables).
5. By taking appropriate measures, it must be prevented that the cable rods rotate about their axis (except for the tension rods which are moved by the drive means—see first embodiment).
6. The drive means must be absolutely irreversible.
7. The sensor controlling the movement of the transmission must function even if the cabin is empty (δ=0) and when approaching the highest stopping point (if the compensator is situated underneath the cabin).
8. These remarks were compiled assuming a rigidity of the cables equal to ∞ i.e. infinity.
9. With regard to the second and third solution of the second embodiment, an expert opinion by the “Consiglio Nazionale delle Ricerche” was to be obtained on the question, whether “F₄ during empty operation” must be greater than ≧2 Q or 3 Q or otherwise (“F₄ during empty operation” means that the cabin is unloaded=δ=O).
10. The compensation of the lift may be attained by using 2-3-4-5-6-7-8-9-10 or even more springs, arranged appropriately on each cable.
11. In lifts making use of this principle (second and third solution of the second embodiment) steel cables having e textile core must be used, which must all “for the same lift” comprise strands having the same torque (all with torque to the right or all with torque to the left).
12. If cables are used having a shortened stretch, the compensation of the lift by compensating the cable lengths can be attained only by means or a device arranged underneath the cabin—in the case of considerable cable lengths two devices should be employed (one for the cables above the cabin and the counter-weight and one for the cables which connect the cabin and the counter-weight on the underside), (see third solution of the second embodiment).
13. According to the experience, Seale-cables having 6 strands, 114 wires and a textile core are best suited. They exhibit the lowest stretch.
14. K₃ₙ, represents the rigidity of the springs 14 or K_{M14}.
15. K₂ₙ represents the rigidity of the springs 13 or K_{M13}.
16. K₁ₙ represents the rigidity of the springs 12 or K_{M13}.
17. “n” represents the number of traction cables.
18. The second and third solution or the second embodiment was found taking into account that the cabin is loaded by the upper cable pulley, clamped in place by the motor brake.
19. In FIG. 6, “36” denotes the adjustable stopping device of the spring M₁₄.
20. The rigidity of the springs applied to the cables is always calculated by starting from the reference base of the “n” springs M₁₂; it will always be:

$${K}_{M 12} = \frac{Q}{n \cdot 15} \frac{N}{mm}$$

The parameter 15 of the above stated formula may also be changed, but may never exceed the actual value “25” [(representing the values permissible in accordance with the European legal regulations); (step which the cabin threshold forms with the floor level threshold if the cabin itself is loaded with the nominal load “Q”)].
21. The reference numbers 2-5-6 are identical to the reference number according to FIG. 1.
22. The second and third solution of the second embodiment is proposed by making the assumption that the lift unit has only one single cable (not a realistic case).
23. The two solutions which may attain the compensation of the installation, i.e. the second and the third solution of the second embodiment, are to be adjusted with the cabin positioned on the same level as the counter-weight and provided that the weight of the cabin (together with all its accessories) plus the weight of the cables is equal to the carrying capacity “Q”.

1. Process for stretch compensation in lift cables, characterized in that the lift cable is enveloped by windings in order to increase the specific number of strand windings of the cable.

2-17. (canceled)

18. A lift cable stretch compensation system arranged within a lift unit, said lift cable stretch compensation system comprising:
a lift unit having a cabin having a cabin floor, a counter-weight, at least one suspension cable attachable to said cabin and said counter-weight and being suspended by a pulley, and at least one cable attachable to an underside of said cabin and counter-weight and running around a freely rotating pulley positioned in a lift shaft;
a drive means being fixed to the opposite side of said cabin floor, said drive means being mechanically connected to an end of at least one tension rod on the underside of said cabin; and
at least one spring being applied to a section of said suspension cable in said cabin, said spring including at least one sensor which serves to trigger said drive means.

19. The lift cable stretch compensation system according to claim 18, wherein said drive means being carried by a base plate attachable to said cabin floor, said drive means comprising an output shaft including a pinion, said cable stretches within a tension rod passing through apertures defined in said base plate, said output shaft of said drive means being situated parallel to said tension rod, and wherein a link chain being wound around said pinion and around at least one chain wheel, said tension rod being fitted to said chain wheel, said chain wheel being situated in the same plane of said pinion.

20. The lift cable stretch compensation system according to claim 19, wherein said at least one spring moves said sensor, controlling said drive means.

21. The lift cable stretch compensation system according to claim 20, wherein said drive means is irreversible.

22. The lift cable stretch compensation system according to claim 21, wherein said suspension cable having a tension rod at its ends, said suspension cable tension rods, which are not moved by said drive means, may not rotate about their axis.

23. The lift cable stretch compensation system according to claim 22, wherein said lift cable stretch compensation system is provided in order to increase the number of windings of the strands in one lift system having from one up to five cables.

24. The lift cable stretch compensation system according to claim 23, wherein said drive means, and said tension rod including said chain wheel being fitted to said base plate, said sensor which is mounted on said spring located on an upper side of said cabin and which detects the stretch of said cable.

25. The lift cable stretch compensation system according to claim 24, wherein said tension rod passing through said aperture in said base plate traversing a bearing and being screw-connected by a nut and a counter-nut, so that said tension rod can rotate freely about its own axis prior to installing said link chain and prior to said cable being fitted to said corresponding tension rod.

26. The lift cable stretch compensation system according to claim 25, wherein said cable being attached to said counter-weight via a tension rod.

27. The lift cable stretch compensation system according to claim 26, wherein said suspension cable and said cable being connected to their corresponding said tension rods by a connection.

28. The lift cable stretch compensation system according to claim 27, wherein said sensor actuating said drive means is only in operation when the empty cabin is stopped at a highest level of a lift journey, when said counter-weight is at its minimum distance in relation to an overrun support.

29. The lift cable stretch compensation system according to claim 28, wherein said counter-weight comprising a first and second spring wherein said first spring is positioned above and in contact with the upper cross arm of said counter-weight and wherein said second spring is positioned below and in contact with said upper cross arm of said counter-weight, wherein said tension rod connected to said suspension cable passes through said upper portion of said counter-weight and said first and second springs and wherein the ends of said first and second spring are connected to the same said tension rod.

30. The lift cable stretch compensation system according to claim 29, wherein said nut and counter-nut positioned above the said first spring and below the said second spring are adjustable and that the rigidity of said second spring and said spring connected to said suspension cable section in said cabin are identical and that the rigidity of said first spring is twice as much as that of said second spring and said spring connected to said suspension cable section in said cabin.

31. The lift cable stretch compensation system according to claim 30, wherein said suspension cable tension rod attachable to said upper portion of said counter-weight passes through an aperture defined in said upper portion of said counter-weight and is attachable to a spring positioned in the interior of said counter-weight, wherein said spring having one end adjacent said upper portion and an opposite end attachable to said tension rod of said suspension cable, and further comprising a second spring located exterior of said counter-weight and having one end adjacent said upper portion and an opposite end to said suspension cable tension rod.

32. The lift cable stretch compensation system according to claim 31, wherein when the length of the cables is considerable, it is required an additional lift cable stretch compensation system positioned on the upper part of the said counter-weight and similar to that one positioned on the opposite side of the said cabin floor.
